(19) United States
(12) Patent Application Publication
(10) Pub. No.: US 2019/0004206 A1
(43) Pub. Date: Jan. 3, 2019

(54) SYSTEM AND METHOD FOR GRAVITY AND/OR GRAVITY GRADIENT TERRAIN CORRECTIONS

(71) Applicant: CGG SERVICES SAS, Massy Cedex (FR)

(72) Inventors: Xiong LI, Houston, TX (US); Nathan FOKS, Lakewood, CO (US)

(21) Appl. No.: 15/737,774

(22) PCT Filed: Aug. 4, 2016
(86) PCT No.: PCT/IB2016/001242

§ 371 Date: Dec. 19, 2017

Related U.S. Application Data
(60) Provisional application No. 62/204,613, filed on Aug. 13, 2015.

(51) Int. Cl. G01V 7/06

(52) U.S. Cl. CPC G01V 7/06

(57) ABSTRACT

Systems and methods for calculating gravity and gravity gradient terrain effects. The method includes a step of receiving a digital relief model (DRM) and gravity and/or gravity gradient data recorded at observation stations; a step of calculating with a computing device gravity and/or gravity gradient terrain effects at observation stations based on (i) a triangulated surface of the DRM and (ii) an adaptive triangulation method; a step of removing the gravity and/or gravity gradient terrain effects from the gravity and/or gravity gradient data to obtain gravity and/or gravity gradient terrain corrected data; and a step of generating gravity and/or gravity gradient anomalies of a surveyed subsurface based on the gravity and/or gravity gradient terrain corrected data.

### CROSS-REFERENCE TO RELATED APPLICATION

This application claims the benefit under 35 U.S.C. § 119(e) of United States Provisional Application Serial No. 62/204,613, filed on Aug. 13, 2015, which is incorporated by reference in its entirety for all purposes.

### TECHNICAL FIELD

The present disclosure relates to gravity-based geophysical exploration, and, more particularly, to gravity and/or gravity gradient terrain corrections using an adaptive triangulation technique.

### BACKGROUND OF THE INVENTION

Gravity modeling is a technique of geophysical exploration that uses measurements of variations in the earth's gravitational field to estimate properties of the earth's subsurface. The gravity of the earth has an average value of 9.8 m/s², but it actually varies from 9.78 at the equator to 9.83 at the poles. Density variations of the earth's interior contribute to these gravity variations. Gravity exploration uses measurements of these gravity or gravity gradient variations to study the interior of the earth.

The instrument used to measure gravity can be called a gravimeter or a gravity meter. An absolute gravimeter measures the absolute gravity value, for example, a value near 9.8 m/s². A relative gravimeter measures relative gravity, for example, the difference between a gravity value at one location and a gravity value at a base station. Almost all modern relative gravimeters use a metal or quartz spring as a gravity measurement device.

Gravity data can be acquired, using a gravimeter, on land, on the sea surface (from a moving marine vessel), on the seafloor, in air (on a flying aircraft, or on a satellite), or in borehole. A land gravity survey is typically static: gravity meters remain at a location for minutes while taking readings, and then move to the next location. Each location is called a station. Ideally, the distribution of land survey stations will be regular. In contrast, marine and airborne gravity surveys are dynamic: measurements are taken along pre-defined vessel and flight lines. Data are sampled along these lines using a certain sampling rate (in time or distance). In a typical land survey, one or more gravimeters may be used. In a typical marine or airborne survey, generally, only one gravimeter is used.

The locations of land stations and line samplings may be defined by (X, Y, Z) coordinates, and these coordinates are routinely determined by GPS. Gravity readings and their (X, Y, Z) coordinates can be exported from a gravimeter system to a data storage device.

The variation in measured gravity and/or gravity gradient values is attributable to a combination of many effects. For example, the measurement may be influenced by the gravitational attraction of the moon and the sun, or the drift effect due to an imperfection of the materials used to build a gravimeter. However, in gravity modeling, only the gravity and/or gravity gradient effects due to density variations of the earth's interior are of interest. Thus, a systematic process is used to estimate or compute these unwanted effects and then remove them from the measured gravity and/or gravity gradient data.

The remaining value is called a gravity anomaly and this anomaly may be indicative of the underground structure of the earth.

Generally, the gravity unit of m/s² is too big for exploration applications. Thus, typically mGal is used as the unit of the gravity anomaly, where 9.8 m/s²=980000 mGal. A typical peak-to-peak range of gravity anomalies in a gravity exploration project is about a few to tens of mGal.

Gravity modeling is one way to interpret gravity data. Interpretation is the process of delineating the subsurface structure and density distribution from observed gravity data. Gravity modeling typically includes building an initial subsurface structural (i.e., geometric) model that consists of layers and closed bodies, assigning initial density values to these layers and bodies, computing the gravity responses produced by the model, and then comparing the observed gravity anomaly and the calculated gravity responses. If the observed gravity anomaly and the computed gravity responses don't match, either the structural model, the density values, or both are edited. Subsequently, the calculated gravity responses are recalculated and again compared to the observed gravity anomaly. This process may be repeated so that the observed gravity and the calculated gravity match in, for example, a least squares sense. The end result is a final structural and density model that interprets the observed gravity reasonably well. However, the observed gravity anomaly is affected by terrain effects.

Terrain corrections need to be taken into consideration when processing the data from a gravity or gravity gradient survey. The terrain correction is used to account for mass excess or mass deficit within a region surrounding a measurement location. The terrain correction, when used in addition to the simple Bouguer correction, provides the complete Bouguer correction for gravity and/or gravity gradient data. Historically, contour maps were used along with Hammer charts (Hammer, S., 1939, Terrain corrections for gravimeter stations: Geophysics, 4, 184-194), to obtain an estimate of the amount of mass excess or deficit. More recently, there is access to dense digital elevation models that cover large regions of the earth, which can be analyzed using computers (Kane, M. F., 1962, A comprehensive system of terrain corrections using a digital computer: Geophysics, 27,445-462 and Cogbill, A., 1990, Gravity terrain corrections calculated using digital elevation models: Geophysics, 55, 102-106). However the processing of such large models is computationally demanding. To compute the terrain effect from the Digital Elevation Model (DEM), the DEM is first approximated by prisms. As discussed later, the DEM may be replaced by DRM when both land topography and marine bathymetry are considered. The most common form of approximation or representation is one that uses rectangular prisms. Rectangular prisms have been used in a quadtree mesh discretization sense by Davis et al. (Davis, K., M. Kaas, Rapid gravity and gravity gradiometry terrain corrections via an adaptive quadtree mesh discretization: Exploration Geophysics, 42, 88-97), where the rectangular cells are formed based on an error tolerance. One drawback of purely rectangular prism based methods is the step like representation of the elevation model. The steps can create a large vertically offset mass close to an observation locations, and is therefore not suited to ground based surveys. Instead, more flexible meshes using triangular elements have been used to represent the DEM continuously. Triangular meshes remove the large vertical offsets in the discretization, and hence do not contain artifacts pertaining to those offsets. Zhou et al. (Zhou, X., B. Zhong, and X. Li, 1990, Gravimetric terrain corrections by triangular-element method: Geophysics, 55, 232-238) use triangular elements that are symmetrical about an observation location. Holzrichter (2013, Processing and interpretation of satellite and ground based gravity data at different lithospheric scales: PhD thesis, Institut fur Geowis-senschaften, Christian-Albrechts-Universitat zu Kiel) uses an adaptive triangulation method, where each initial triangular element is iteratively subdivided into smaller elements. Since each initial element is subdivided independently from its neighbors, there is the tendency to create hanging nodes in the triangular mesh. The hanging nodes again introduce vertical offsets in the DEM representation and hence reduce the accuracy. Meshes using a combination of triangular and rectangular elements have also been used (Tong and Guo, 2007, Gravity terrain effect of the seafloor topography in Taiwan: Terr. Atmos. Ocean. Sci., 18, 699-713).

Thus, there is a need to have a more accurate and efficient way for calculating terrain corrections. The present disclosure includes system and methods directed towards more efficient terrain correction calculations.

### SUMMARY

According to an embodiment, there is a method for calculating gravity and gravity gradient terrain effects. The method includes receiving a digital relief model (DRM) and gravity and/or gravity gradient data recorded at observation stations; calculating with a computing device gravity and/or gravity gradient terrain effects at observation stations based on (i) a triangulated surface of the DRM and (ii) an adaptive triangulation method; removing the gravity and/or gravity gradient terrain effects from the gravity and/or gravity gradient data to obtain gravity and/or gravity gradient terrain corrected data; and generating gravity and/or gravity gradient anomalies of a surveyed subsurface based on the gravity and/or gravity gradient terrain corrected data.

According to another embodiment, there is a computing device that implements the method disclosed above. The computing device includes an interface for receiving a digital relief model (DRM) and gravity and/or gravity gradient data recorded at observation stations; and a processor connected to the interface. The processor is configured to calculate gravity and/or gravity gradient terrain effects at observation stations based on (i) a triangulated surface of the DRM and (ii) an adaptive triangulation method, remove the gravity and/or gravity gradient terrain effects from the gravity and/or gravity gradient data to obtain gravity and/or gravity gradient terrain corrected data, and generate gravity and/or gravity gradient anomalies of a surveyed subsurface based on the gravity and/or gravity gradient terrain corrected data.

According to another embodiment, a non-transitory computer-readable medium including computer-executable instructions carried on the computer-readable medium is disclosed. The instructions, when executed, cause a processor to perform the methods discussed above.

### BRIEF DESCRIPTION OF THE DRAWINGS

For a more complete understanding of the present disclosure and its features and advantages, reference is now made to the following description, taken in conjunction with the accompanying drawings, in which like reference numbers indicate like features and wherein:

FIG. 1 is a synthetic digital elevation model (DEM);

FIG. 2A illustrates an arbitrary triangulation of a set of points and FIG. 2B shows a Delaunay triangulation of the same points;

FIG. 3 is flowchart of a method for calculating gravity and/or gravity gradient effects;

FIG. 4 is an example of an expected-error based discretization;

FIG. 5A is an adaptive quadtree-based triangulation for a single observation location and FIG. 5B is a zoom in of the single observation location;

FIG. 6 illustrates an iterative splitting of four triangles by bisecting their longest edges;

FIG. 7 illustrates iteratively splitting faces without connectivity to adjacent facets, which results in hanging nodes;

FIG. 8 illustrates a triangle splitting algorithm;

FIG. 9 illustrates hanging nodes;

FIG. 10 illustrates a process of facet splitting with back propagated node;

FIG. 11 illustrates a coast line of a synthetic DEM;

FIG. 12 illustrates the adaptive triangulation of the DEM after coastline insertion;

FIG. 13 illustrates triangle categories before coastline insertion;

FIG. 14 illustrates triangle categories after coastline insertion;

FIGS. 15A-15C illustrate terrain corrections' characteristics (computing time, number of triangles per datum, and accuracy) for various DEM resolutions using different global error tolerances;

FIGS. 16A-16D illustrate the time to evaluate the terrain effect, the number of triangles per datum, the maximum error between full and adaptive method, and the number of time the adaptive method is faster than the full calculation for a single DEM with high resolution;

FIG. 17 is flowchart of a method for calculating gravity and/or gravity gradient effects;

FIG. 18 is flowchart of another method for calculating gravity and/or gravity gradient effects;

FIG. 19 is a flowchart of still another method for calculating gravity and/or gravity gradient effects; and

FIG. 20 is a schematic diagram of a computing device that can implement one or more of the above methods.

### DETAILED DESCRIPTION

The present disclosure relates to systems and methods for computing terrain corrections. The following description of the embodiments refers to the accompanying drawings. The same reference numbers in different drawings identify the same or similar elements. The following detailed description does not limit the invention. Instead, the scope of the invention is defined by the appended claims. Some of the following embodiments are discussed, for simplicity, with regard to the terminology and structure of a land gravity survey. However, the embodiments to be discussed next are not limited to land, but may be extended to marine or airborne or borehole surveys.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

According to an embodiment, a method is presented for computing the terrain correction using unstructured meshes of triangular elements. The unstructured mesh will represent the DEM more accurately than a cuboidal representation because the elements in the mesh can dip with the topography. To reduce the computational costs of the terrain correction, the method uses an adaptive mesh discretization approach by iteratively refining the size of the triangular elements according to a pre-specified user tolerance. The method of mesh refinement eliminates the presence of hanging nodes in the mesh, thereby removing false vertical offsets. Prior to discussing this method, two forward modeling algorithms for triangular facets are introduced and then the adaptive triangulation is discussed. Then, the computational aspects of the algorithm are analyzed as well as its numerical accuracy using a synthetic example.

### Forward Modelling

To compare results, two algorithms for forward modeling the gravity response due to triangular facets are used. The first is the direct calculation using an analytical solution and the second, is a faster numerical integration technique to approximate the gravity response. Some theory on gravity is first presented followed by the two methods to calculate the gravity response.

The gravitational potential at a point P′ due to a volume element with density p and location P is given by:

$$δ {U}_{{P}^{′}} = \frac{G ρ}{R} δ v , \qquad ( 1 )$$

where G is the gravitational constant and the distance from P to P′ is R, which is given by R=\sqrt{(x′−x)²+(y′−y)²+(z′−z)²}. By integrating equation (1) over the volume, the total potential is obtained:

$${U}_{{P}^{′}} = G ρ \int \int \int \frac{1}{R} dv . \qquad ( 2 )$$

A component of the gravitational field is obtained by using the corresponding unit vector, i.e.,

g_{M}=∇Uₚ,M, (3)

and thus,

$${g}_{M} = - G ρ \int \int \int ∇ \cdot ( \frac{M}{R} ) dv . \qquad ( 4 )$$

The volume integral of equation (4) can be expressed as a surface integral, by using the divergence theorem, resulting in:

$${g}_{M} = - G ρ \int {\int }_{S} \frac{M \cdot \hat{n}}{R} ds , \qquad ( 5 )$$

where S is the bodies surface and \hat{n} is the unit vector pointing outward and normal to the surface element ds. By discretizing the surface of the body into multiple triangular facets, it is possible to express equation (5) as a summation of integrals over those facets, as follow:

$${g}_{M} = - G ρ {\sum }_{i} M \cdot {\hat{n}}_{i} {I}_{i} , \qquad ( 6 )$$

where \hat{n}ᵢ is the unit vector pointing outward and normal to the i^{th} facet and where

$${I}_{i} = \int {\int }_{Δ {S}_{i}} \frac{1}{R} ds . \qquad ( 7 )$$

Evaluation of the gravity response lies heavily with the solution of equation (7). Two methods are used to evaluate this equation, the analytical solution and the Gaussian quadrature. It should be noted here that the terrain correction involves two evaluations of the surface integral for each triangular element. The first corresponds to the topographic height, while the second corresponds to mean sea level. In such a scenario, the complete Bouguer effect is computed, not just the effects from terrain. Hence the correction calculation can be expressed as:

$$Δ {g}_{TC} = G ρ ( \int {\int }_{{S}_{2}} \frac{1}{R} ds - \int {\int }_{{S}_{1}}^{ } \frac{1}{R} ds ) . \qquad ( 8 )$$

### Analytical Solution

The analytical solution follows the method of Barnett (1976, Theoretical modeling of the magnetic and gravitational fields of an arbitrarily shaped three-dimensional body: Geophysics, 41, 1353-1364), which splits an arbitrarily shaped body into multiple triangular facets along its sides.

Given an observation location P′=(x′,y′,z′) and a triangular facet with coordinates x=(x₁,x₂,x₃), y=(y₁,y₂,y₃), and z=(z₁,z₂,z₃), it is desired to evaluate equation (7). Following Barnett, first rotate to a uvw-coordinate sys-tem where w is the axis perpendicular to the facet, and where the u axis is parallel to one of the sides,

u=lₓx+l_{y}y+l_{z}z

v=mₓx+m_{y}y+m_{z}z ,

w=nₓx+n_{y}y+n_{z}z (9)

where n=(nₓ, n_{y}, n_{z}) is the unit vector normal to the facet, l=(lₓ, l_{y}, l_{z}) is the unit vector pointing from vertex 1 to vertex 3 and m =(mₓ, m_{y}, m_{z})=n×l is the unit vector that makes up the orthogonal right-handed triad with n and l.

Next, the method translates the coordinate system to the origin by subtracting the observation location, i.e.,

p=lₓx−x′+l_{y}y−y′+l_{z}z−z′

q=mₓx−x′+m_{y}y−y′+m_{z}z−z′.

r=nₓx−x′+n_{y}y−y′+n_{z}z−z′ (10)

Barnett (1976) provides the evaluation of the surface integral as follows:

$$\begin{matrix}{I}_{i} = {h}_{1} cos {α}_{1} ln [ \frac{{p}_{1} sin {α}_{1} + {q}_{1} cos {α}_{1} + {R}_{1}}{{p}_{2} sin {α}_{1} + {q}_{2} cos {α}_{1} + {R}_{2}} ] - {h}_{2} cos {α}_{2} ln [ \frac{{p}_{3} sin {α}_{2} + {q}_{1} cos {α}_{2} + {R}_{3}}{{p}_{2} sin {α}_{2} + {q}_{2} cos {α}_{2} + {R}_{2}} ] + {q}_{1} ln [ \frac{{p}_{1} + {R}_{1}}{{p}_{3} + {R}_{3}} ] + 2 {r}_{1} [ {tan}^{- 1} ( \frac{{q}_{1} cos {α}_{1} + ( 1 + sin {α}_{1} ) ( {p}_{1} + {R}_{1} )}{{r}_{1} cos {α}_{1}} ) ] - {tan}^{- 1} ( \frac{{q}_{2} cos {α}_{1} + ( 1 + sin {α}_{1} ) ( {p}_{2} + {R}_{2} )}{{r}_{1} cos {α}_{1}} ) - {tan}^{- 1} ( \frac{{q}_{1} cos {α}_{2} + ( 1 + sin {α}_{2} ) ( {p}_{3} + {R}_{3} )}{{r}_{1} cos {α}_{2}} ) + {tan}^{- 1} ( \frac{{q}_{2} cos {α}_{2} + ( 1 + sin {α}_{2} ) ( {p}_{2} + {R}_{2} )}{{r}_{1} cos {α}_{2}} ) , \\ \text{where:} & ( 11 ) \\ {g}_{1} = tan ( {α}_{1} ) = ( {p}_{2} - {p}_{1} ) / ( {q}_{2} - {q}_{1} ) \\ {g}_{2} = tan ( {α}_{2} ) = ( {p}_{2} - {p}_{3} ) / ( {q}_{2} - {q}_{1} ) \\ {h}_{1} = ( {p}_{1} {q}_{2} - {p}_{2} {q}_{1} ) / ( {q}_{2} - {q}_{1} ) \\ {h}_{2} = ( {p}_{3} {q}_{2} - {p}_{2} {q}_{1} ) / ( {q}_{2} - {q}_{1} ) . \\ {R}_{1} = \sqrt{{p}_{1}^{2} + {q}_{1}^{2} + {r}_{1}^{2}} \\ {R}_{2} = \sqrt{{p}_{2}^{2} + {q}_{2}^{2} + {r}_{1}^{2}} \\ {R}_{3} = \sqrt{{p}_{3}^{2} + {q}_{1}^{2} + {r}_{1}^{2}} & ( 12 )\end{matrix}$$

The solution based on Barnett's method is slow compared to other analytical and numerical solutions. This algorithm is stable when the observation location is outside the source region. If the observation location is outside, but close to a body that may have a negative vertical gravity response, care must be taken during the calculation.

### Numerical Solution

The numerical solution to the terrain correction follows that of Zhou et al. (1990), which uses a Gaussian quadrature to evaluate equation (7). Quadrature is a widely used numerical technique when integration is difficult.

Given the surface integral in equation (7), it can be expressed in terms of a summation over Gaussian quadrature coefficients, as follows:

$${I}_{i} = \int {\int }_{Δ {S}_{i}}^{ } \frac{1}{R} ds = {A}_{i} {\sum }_{p = 1}^{np} \frac{{W}_{p}}{{R}_{p}} , \qquad ( 13 )$$

where np is the number of Gaussian quadrature points for a specified polynomial order, Aᵢ is the area of the i^{th} facet projected to the X-Y plane, Wₚ is the Gaussian quadrature weight and Rₚ is the distance to the Gaussian quadrature point. The terrain effect in equation (8) can be reduced somewhat, as in Zhou et al.(1990). For a single triangular facet,

$$Δ {g}_{TC}^{i} = G ρ {A}_{i} {\sum }_{p = 1}^{np} ( \frac{{W}_{p}}{{R}_{1 p}} - \frac{{W}_{p}}{{R}_{2 p}} ) . \qquad ( 14 )$$

In Dunavant (1985, High degree efficient symmetrical gaussian quadrature rules for the triangle: International Journal for Numerical Methods in Engineering, 21, 1129-1148), a table presents four coefficients associated with each Gaussian quadrature point. The first two columns are simplex coordinates, the third simplex coordinate is one minus the first two (these are used to linearly map an arbitrarily oriented triangle to the unit triangle, and the fourth coefficient is the Gaussian quadrature weight. The simplex coordinates accomplish two goals in one step, first they linearly map three vertices of an arbitrary triangle to the unit triangle, and second they interpolate the function values at those nodes to the Gaussian point location. In the present application, the interpolation is performed between the three vertices of the triangle that represent the DEM. Given the interpolated coordinates, it is possible to evaluate the radial distance and hence function 1/R for the Gaussian point location. Then, the function evaluation is weighted by the corresponding Gaussian weight.

The Gaussian quadrature coefficients given in Dunavant (1985) are pre-calculated by specifying the order of the polynomial used for interpolation. A higher order polynomial leads to more Gaussian quadrature coefficients that increases the solution accuracy but also increases the computational cost.

Given an observation location P′=(x′,y′,z′) and a triangular facet with coordinates x=(x₁,x₂,x₃), y=(y₁,y₂,y₃), z=(z₁,z₂,z₃), it is desired to evaluate equation (7). The observation location is subtracted from the vertex coordinates to compute the response at the origin. Next, the Gaussian quadrature is applied. For example, consider a single Gaussian quadrature point p=1 and use the simplex coordinates to interpolate the three vertices to the location of the Gaussian point as follows:

xiₚ=x·SCₚ

yiₚ=y·SCₚ,

ziₚ=z·SCₚ (15)

where SCₚ are the simplex coordinates for the p^{th} Gaussian point. The interpolated DEM value is now used to evaluate the radii R′ₚ and Rₚ,

R₁ₚ=\sqrt{xi₁ₚ²+yi₁ₚ²+zi₁ₚ²} (16)

R₂ₚ=\sqrt{xi₂ₚ²+yi₂ₚ²+zi₂ₚ².} (17)

These computations are carried out for each Gaussian point and hence, the entire terrain correction for a single datum is:

$$Δ {g}_{TC} = G ρ {\sum }_{i = 1}^{Ntri} {A}_{i} {\sum }_{p = 1}^{np} ( \frac{{W}_{p}}{{R}_{1 p} - {R}_{2 p}} ) . \qquad ( 18 )$$

While the numerical solution is an approximation to the gravity response, its calculation is much faster than that of Barnett's method. However, if the observation location is located exactly on a triangles vertex, the reciprocal of the radius becomes infinity and the solution is unstable.

### Method

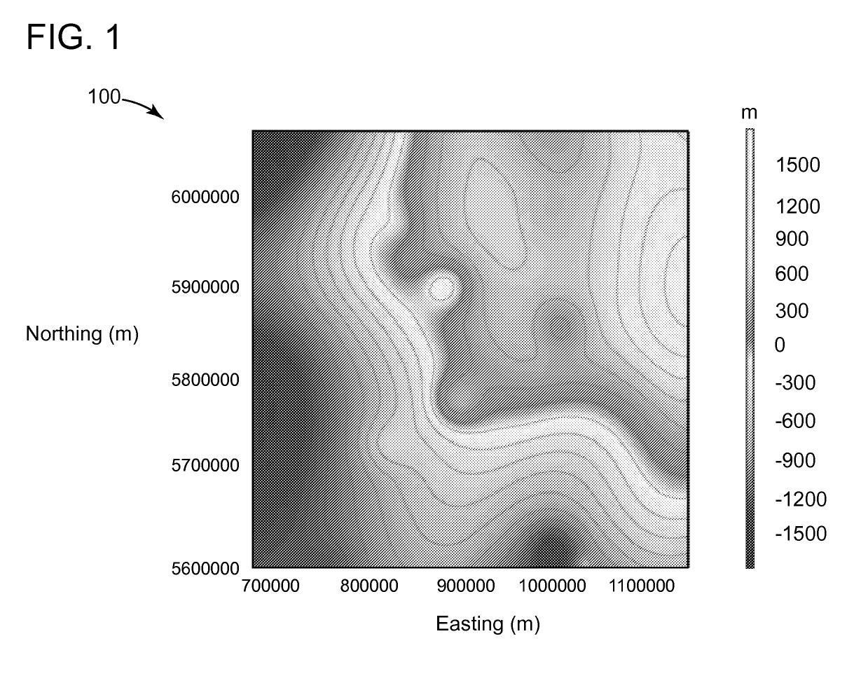

Before the adaptive terrain correction method is discussed, a synthetic example is introduced as illustrated in FIG. 1. FIG. 1 presents a synthetically generated DEM 100 using 700 randomly distributed Gaussian hills of various lengths and centers. The response from each hill is accumulated on a 513×513 cell grid, with 1 km grid spacing in each direction. The DEM heights ranges from −1620.202 m to 1071.195 m and hence contain a zero contour. This synthetic example will be used to illustrate the method and present some of the advantages of this method.

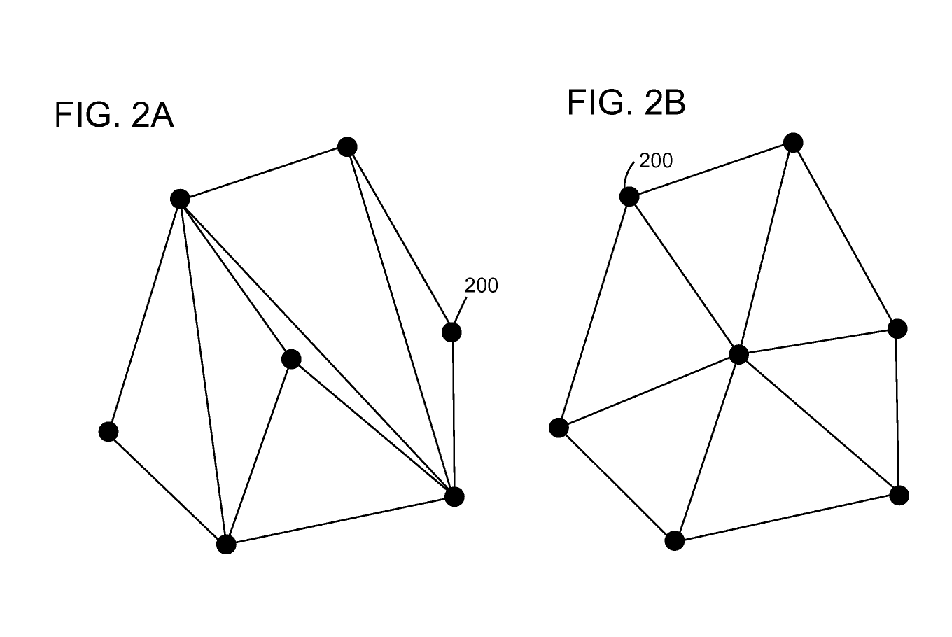

Triangulations are unstructured meshes that generate facets of triangular elements from a distribution of points 200. The most common type of triangulation is Delaunay triangulation, which maintains triangles with nice properties throughout the mesh. A nice triangle is a triangle that is as close as possible to an equilateral triangle and it is not elongated in any one direction. In this respect, FIG. 2A shows an arbitrary triangulation of a set of points while FIG. 2B shows a Delaunay triangulation of the same set of points. A condition of the Delaunay triangulation is that no other point 200 is present inside the circumcircle of another triangle. The use of triangulations to represent DEMs is well known in the GIS (Geographic Information System) community and are also known as Triangulated Irregular Networks (TINs). Since the facets of the triangulation are allowed to dip, the DEM can be more accurately characterized than with a piecewise constant representation using a structured mesh of rectangular prisms. If the entire set of grid nodes from the DEM is triangulated, the computation of the gravity response would be slow. Therefore, the method uses an adaptive algorithm that uses variable facet sizes to discretize the terrain. The adaptive Delaunay triangulation uses the roughness of the DEM, the distance between a station and a prism, and the expected error based discretization of the DEM is performed in step 300. The method also includes a step 302 in which an algorithm splits triangles in a triangulation and a step 304 that inserts a coastline for more accurate representation of the topography-bathymetry interface. These steps are now discussed in more detail.

The second adaptive triangulation technique follows the quad-tree based approach of Davis et al. (2011). However, instead of using a rectangular mesh, the method uses a triangular mesh. The adaptive nature of the mesh will reduce the number of triangles needed to represent the DEM, by assigning large triangular facets to smooth areas of the DEM. Then, the resolution of the triangles is increased by evaluating their gravity response. To increase the resolution of the triangular facets, they are split into two equal portions. Thus, it makes sense to have triangles that are power of 2 in size. Its details are described below.

The initial triangle size determines the coarsest level of resolution for the triangulation, for example 32 grid cells by 32 grid cells (or 33 nodes by 33 nodes). To assign heights from the DEM to the nodes of the triangulation, a multi-grid approach is adopted by applying a set of moving average filters to the DEM with increasing window sizes. This minimizes small scale effects of the DEM on larger triangles since larger facets should naturally represent an average of their DEM height. The window sizes for the moving average filters depend on the initial size of the triangles, for example, an initial triangle of size 32 cells by 32 cells warrants a moving average window of size 32 cells by 32 cells.

Hence the set of moving average filters will use window sizes of [32, 16, 8, 4, 2, 1] for an initial triangulation using 32 cells. As the triangles are split in the mesh, their heights are updated with the heights from the higher resolution DEM. The highest level of triangle with a size of 1, simply uses the heights of the original DEM. In the following method description, the DEM node heights are referred as the heights chosen from the multi-grid, appropriate for the given triangle's size.

To generate a terrain adaptive unstructured mesh, it is defined in step 300 a global error tolerance for the terrain correction, for example, 0.05 mGal. Then the grid nodes that coarsely represent the DEM are chosen, e.g., every 33rd grid node that lies within a user-defined computation radius. The nodes are triangulated using Delaunay triangulation to give an initial triangulation. Each triangular facet is initially assigned a triangle level of 1, a splitting flag of true and a computed flag of false. The global error tolerance is divided equally among the number of initial triangles, for example 100 triangles in the initial mesh would each get a 0.0005 mGal local error tolerance.

To split a triangular facet, its gravity response is calculated for the given observation location. Then the facet is bisected along its longest edge, and the method computes the gravity response from the two new children triangles. The two children triangles are kept, multiply their triangle levels by 2 and assign their computed flag as true. To determine whether the children must be further split, the method compares the gravity response of the parent triangle to the sum of the responses from its offspring. If the difference in the two responses is greater than the parent's local error tolerance, the children must be further split. The children are then assigned a local error tolerance of two times their parent's local error, and their splitting flags are true.

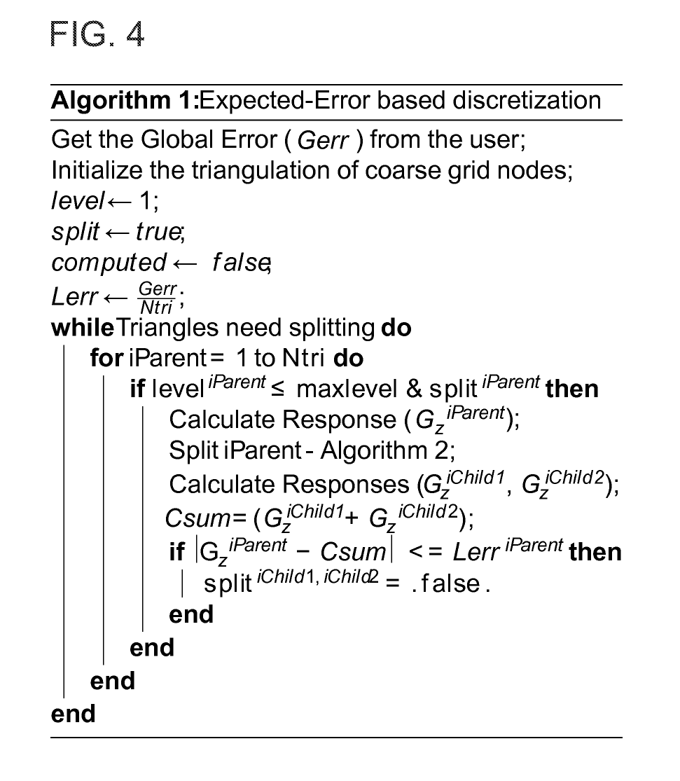

Triangle splitting is continued until either the difference in responses is less than the local error tolerance, or the children have reached the highest triangle level. The highest level triangles have horizontal widths and lengths equal to the DEM spacing. This process is carried out for each triangular facet in the mesh, until no triangles are split. The approach of the Delaunay triangulation followed by iterative splitting is the most computationally demanding component of the algorithm since the index that maintains the triangular facets must be updated. This component of the algorithm is therefore the starting choice for any further optimization. The algorithm illustrated in FIG. 4 highlights the steps of the expected-error based discretization.

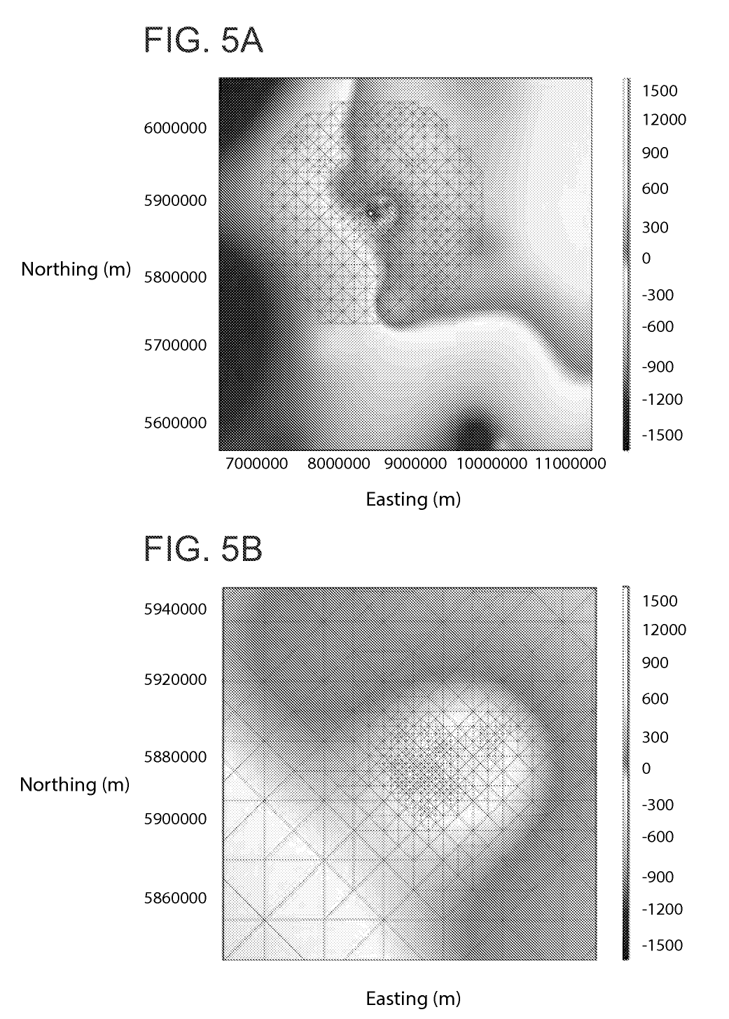

The adaptive triangulation approach is carried out for each datum independently. Therefore each calculation of the terrain effect for each datum is subject to the same error criterion. In this regard, FIG. 5A shows an adaptive triangulation for a single observation location and FIG. 5B shows a zoomed small area of FIG. 5A to highlight the details. The triangulation becomes coarser with distance to the observation location. In areas where the DEM is changing more rapidly, the triangulation becomes finer.

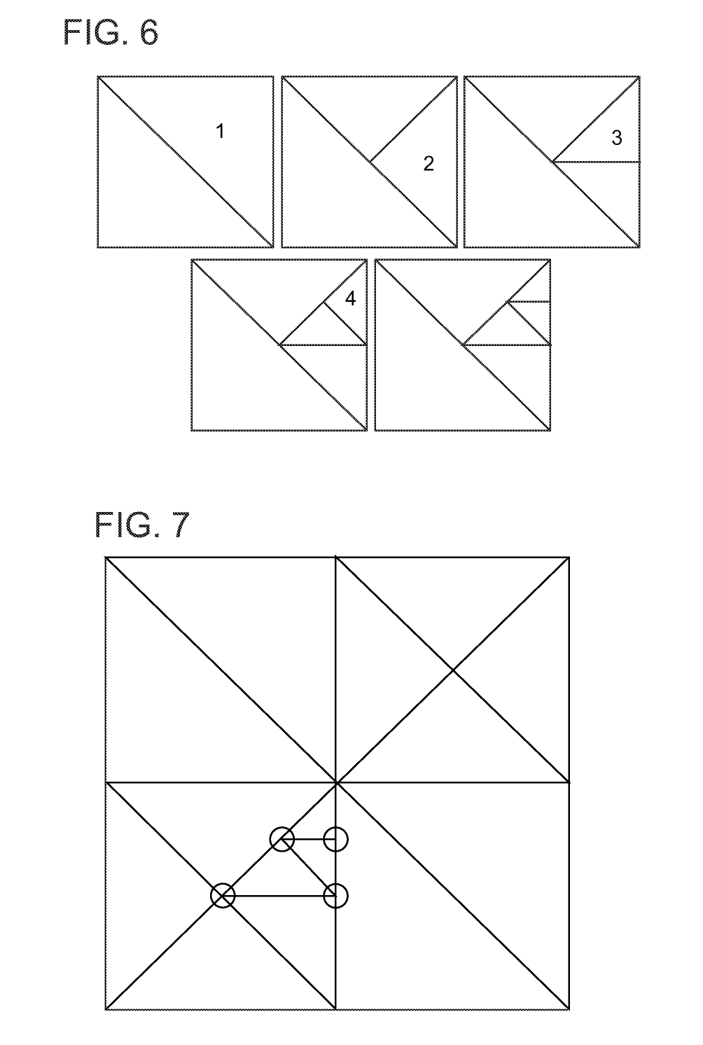

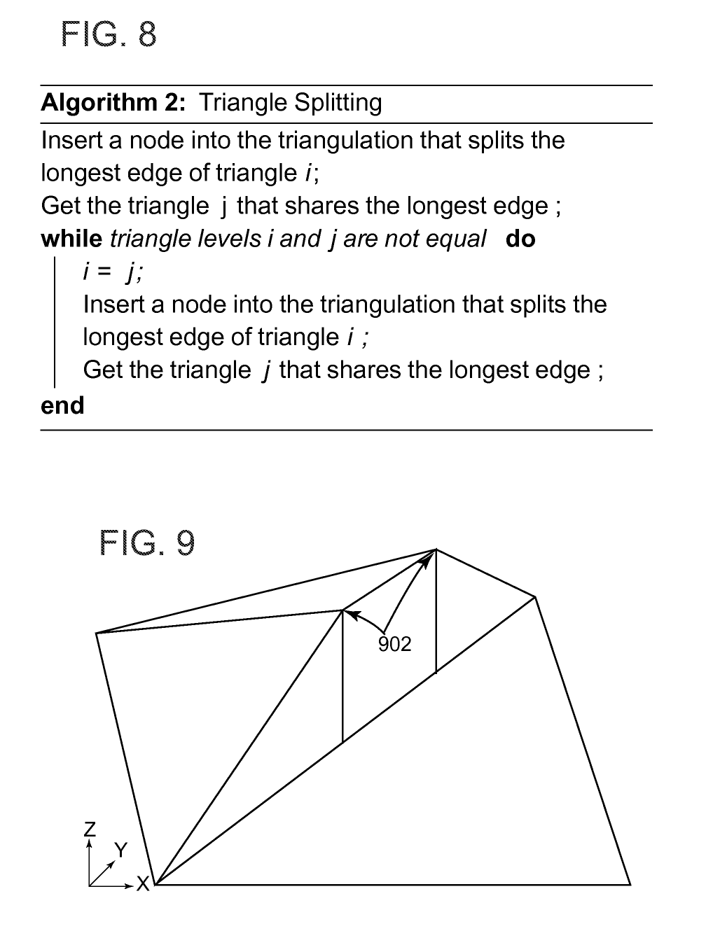

Next, step 302 of splitting triangles in a triangulation such that a continuous surface is maintained is discussed. Given a set of N nodes with Cartesian coordinates x,y,z and a triangulation of those nodes with NT triangular facets, this step splits a parent triangle i such that two children triangles are produced. To split a triangle, for example, simply bisect the parent triangle along its longest edge. FIG. 6 shows a sequence of four splits where each triangle is split along its longest edge. FIG. 7 illustrates this type of splitting when neighboring cells are present. FIG. 8 illustrates an algorithm for triangle splitting.

Since there is no connectivity between each facet, hanging nodes will be generated. Hanging nodes are nodes that lie as the vertices to some triangles but along the edge of another triangle. This creates discontinuities in the surface which are desired to be avoided. To further illustrate this, FIG. 9 shows this concept in 3-dimensions. Hanging nodes 902 are generated in triangulations that are iteratively adapted as in Holzrichter (2013). However, since the triangulation structure is stored in this method, it is possible to avoid hanging nodes by propagating through the triangulation and inserting additional nodes.

The algorithm illustrated in FIG. 8 splits the triangles by inserting points that split the longest edges. The algorithm begins by splitting the parent triangle from the algorithm illustrated in FIG. 4 and then back propagates through the triangulation, inserting points that prevent hanging nodes. For any parent triangle, its two off-springs obtain twice its level, to maintain the stopping criteria in both Algorithms 1 and 2.

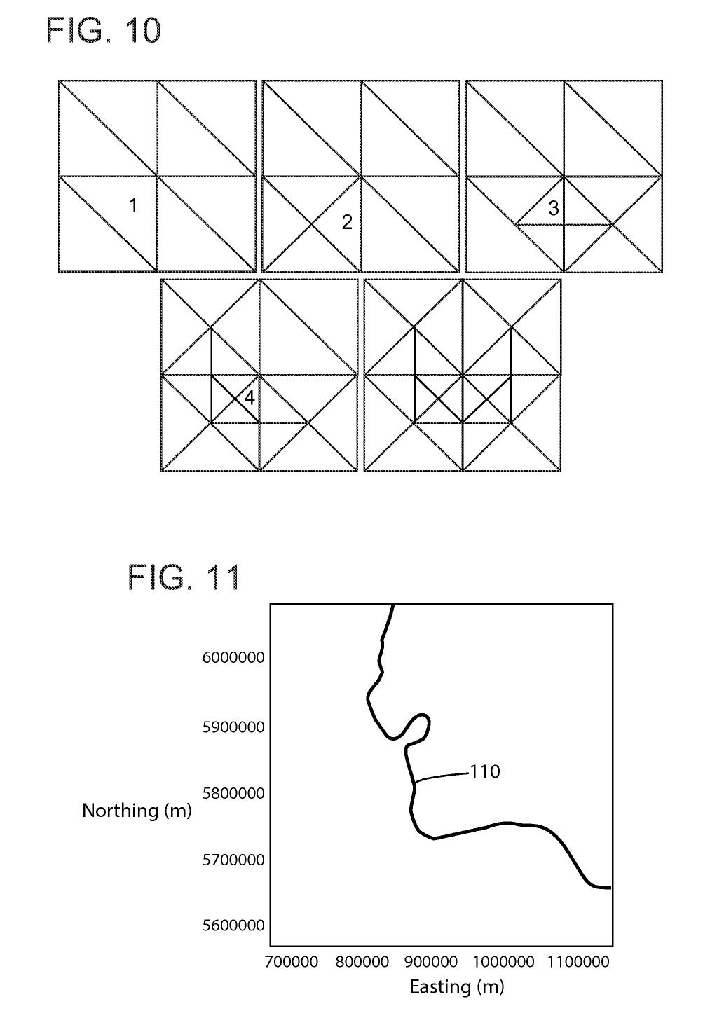

In this respect, FIG. 10 shows the progressive splitting of four triangles. There are no hanging nodes present and the mesh has maintained its continuity and nice triangle properties. The Delaunay triangulation stores the vertex indices for each triangle, and the three adjacent triangle indices in a counter-clockwise direction. This property of the Delaunay triangulation is used to find the triangles that share the longest edges in an O(1) operation, as opposed to a maximum O(Ntri²) search. These computational advantages and conveniences are makes desirable using the Delaunay triangulation.

Step 304 inserts a coastline as now discussed. When the terrain effect of a DEM is calculated, it is possible to assign a single density to the land topography, i.e., mass above sea level. In the case of bathymetry, a single density is assigned and subtract the density of sea water. If the DEM spans the zero contour, or coastline, the adaptive triangulation discussed above will contain facets that span the zero contour, and their nodes will have both positive and negative heights. In this case, assignment of the correct density is difficult since the facet is not defined as either topography or bathymetry.

To accommodate this, a set of line segments are inserted and they represent the coastline into the final adaptive triangulation. This will ensure that facet edges are aligned with the zero contour and the step of assigning densities to the facets on either side of zero is reliable. One artifact of coastline insertion is the presence of long and thin triangles close to the observation point, which can produce erroneous results. Therefore, if a coastline is inserted, the method ensures that triangles close to the observation location, and those that span the zero contour are automatically split, regardless of their error tolerance. The method imposes automatic splitting up to a distance of the initial size of the triangulation away from the observation location, in this example, 32 grid cells. Doing so will allow the triangulation to form nice facets close to both the observation location and coastline and thus maintain reliable results.

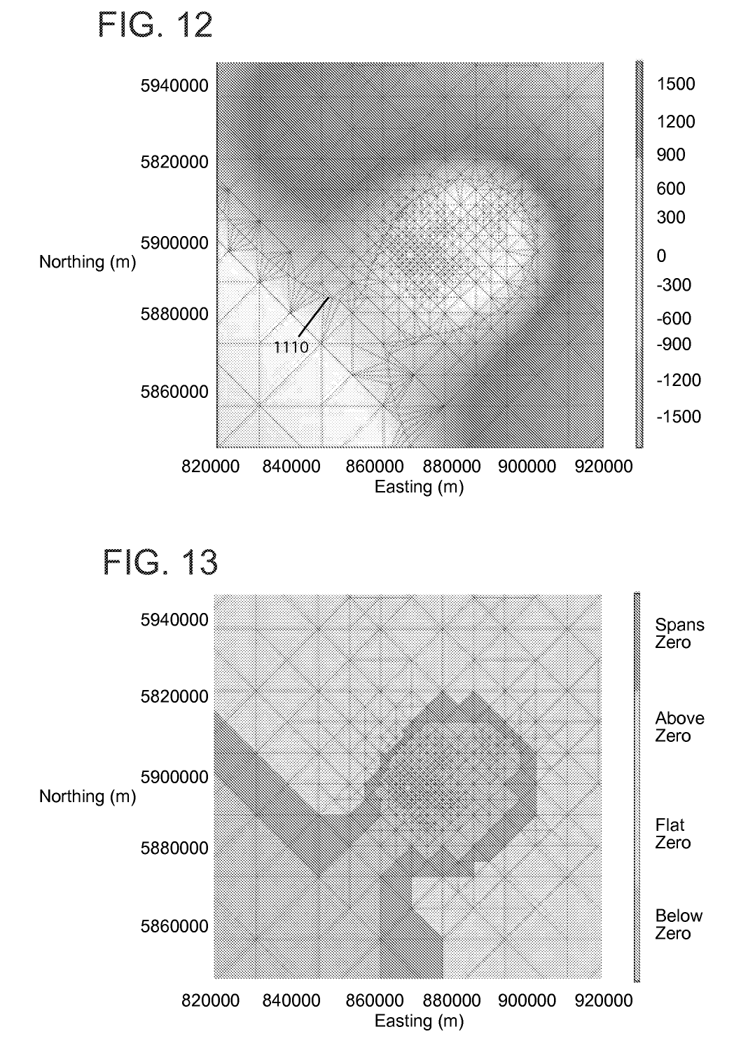

FIG. 11 shows the zero contour 1110 for the synthetic DEM and FIG. 12 shows the insertion of the coastline for the synthetic example of FIG. 1. Note that close to the observation location, a nice triangulation has been maintained. Farther away from the observation location, thin elongated triangles are noted. These occur because the method inserts small line segments into the larger more distant triangles. The numerical stability of these triangles however is not an issue at such a distance.

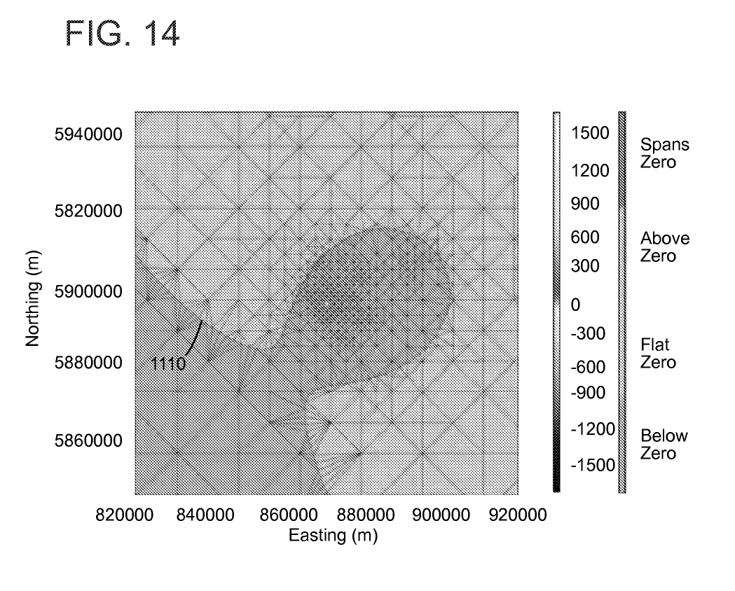

To emphasize the benefit of coastline insertion with regards to density assignment, the method categorizes the triangles based on their heights. Four categories may be used to determine whether a triangle is above, below or span-ning the zero contour, or whether the triangle is entirely flat at zero elevation. FIG. 13 shows the categories before coastline insertion. Note that a band of facets mimics the coastline, but are not reliably assigned a density value. FIG. 14 shows the same categories after coast-line insertion. The facets are now correctly juxtaposed against the zero contour 1110 and their density assignment is successful. In this example, there are no triangles that are entirely flat at zero elevation. Since this algorithm computes the complete Bouguer effect regardless of the survey type (land, airborne, or shipborne), the user of this method simply specifies whether the DEM is land, marine or mixed.

To quantify the accuracy of the adaptive triangulation approach, it is necessary to compute a higher resolution or “full” solution. To carry out the full calculation, it is possible to Delaunay triangulate every DEM grid node and calculate the response within a user-defined computation radius for each observation location. A regularly behaved triangular mesh would be generated where the longest edge of the triangles are preferentially oriented in one direction. This type of regular mesh, however, creates geometric bias in the gravity calculation purely based on the orientation of triangles close to the observation location. To improve on this, the method begins by taking every other DEM grid node which is triangulated. Each facet is then split once along its longest edge such that every DEM grid node is utilized. The result is a dense symmetrically regular mesh that will no longer produce erroneous results due to geometry. To increase the computational efficiency, it is possible to pre-compute three of these meshes. The first begins at the origin of the DEM. The second and third meshes are shifted east and north, respectively, by one DEM grid node. For a single observation location, it is possible to choose from these three meshes the one that provides symmetry about the observation. The chosen symmetrical triangulation maintains accuracy of the algorithm for the full computation and hence provides a more robust comparison.

### Numerical Analysis

The numerical analysis of the method discussed above begins by identifying three cases where the method may be applied. For all comparisons using the numerical solution, the same order polynomial for the Gaussian quadrature method is used. The first case contains observation locations that span the zero contour. The DEM in this first case contains both positive and negative terrain effects near the observation locations. The second case contains only topography with no zero crossing and the third case contains observation locations over water but not close to the shore-line.

### Case 1: Close to the Shoreline

For this case, the observation locations lie on a 2-km by 2-km grid in the center of the DEM and at the nodes of the DEM. The observation heights are located at sea level over DEM values that represent bathymetry, and at the DEM elevation for topography. A computation radius of 167 km for the full gravity solution and the adaptive gravity solution is used, and an initial triangle size of 32 grid nodes and error tolerance of 0.05 mGal for the adaptive approach.

A comparison of the results of these two approaches indicates spikes in the data difference, which are located close to the shoreline. This is an unfortunate artifact of the algorithm using the numerical method for computing the gravity response. The artifacts, however, will only occur for observation locations close to the inserted coastline. The cause of these artifacts is the presence of triangles who strike is at a right angle to the observation location. If the same data difference is plot with the erroneous data removed, the majority of the data are well below the error tolerance of 0.05 mGal. To overcome this limitation, but maintain the speed of the algorithm, it is possible to use the analytical solution of the gravity response for triangles that exhibit this behavior.

### Case 2: Topography

The second case contains only positive DEM values, i.e., effects only from topography, and the observation locations simulate a ground survey in the center of the DEM. The instrument separation is 10 cm, a value specified as an input. The observation locations are placed on a 1 km by 1 km grid and overlain on the DEM, located at the grid nodes. Again the heights are assigned as the DEM value. The data was calculated using the full triangulated method and adaptive triangular methods with both terrain responses being entirely positive. The data calculated using the rectilinear prism based method as in Davis et al. (2011) was also calculated.

When comparing the data, the maximum error for these two data differences are 0.041 mGal and 27.8 mGal. The simulated ground survey has clear instabilities in the rectilinear based terrain correction where the DEM is represented by piece-wise constant cubes. In this example, the full calculation took 884.073 seconds and the adaptive method took 66.655 seconds with these parameters, 13 times faster.

### Case 3: Bathymetry

The third synthetic example contains both positive and negative terrain. However, the observation locations simulate the acquisition heights of a shipborne survey that are not close to the shoreline. The computation for each datum however will require the insertion of the coast-line into the triangulation. The observation heights are constant at 0.1 m. The DEM contains a zero contour to the south, that will influence each evaluation of the terrain response. Since the observation locations lie away from the coastline, it is not expected to have numerical instabilities as in Case Two. The terrain responses for the full and adaptive calculations were obtained with a radius of 167 km, an initial triangle size of 32 nodes and a global error tolerance of 0.05 mGal. The full calculation took 877.026 seconds and the adaptive calculation took 341.021 seconds. The data difference between the two methods indicates a high level of accuracy between the two calculations. Despite the global error tolerance of 0.05 mGal, the maximum error is just 0.0025 mGal. To further analyze the advantages of the method discussed above, a computational analysis is now discussed.

### Computational Analysis

There are three aspects of the method discussed above that are analyzed now. The first is the reduction in the number of triangles when using an adaptive triangulation method over a full calculation. The second is the time needed to run the algorithm and the third is the accuracy of the final computed gravity response. To carry out the analysis, the example from Case 3 discussed above is used. The DEM in Case 3 was generated using a grid spacing of 125 m over 436 km which leads to 3489 grid nodes in both the Northing and Easting directions. This high resolution DEM is down sampled to 250 m, 500 m, and 1000 m grid spacings to provide a suite of DEMs with decreasing resolution. Because the “same” DEM is used in each case, only the three computational analysis aspects listed above are monitored. Further, because the observation locations are not located near the coastline, there is no concern about instabilities.

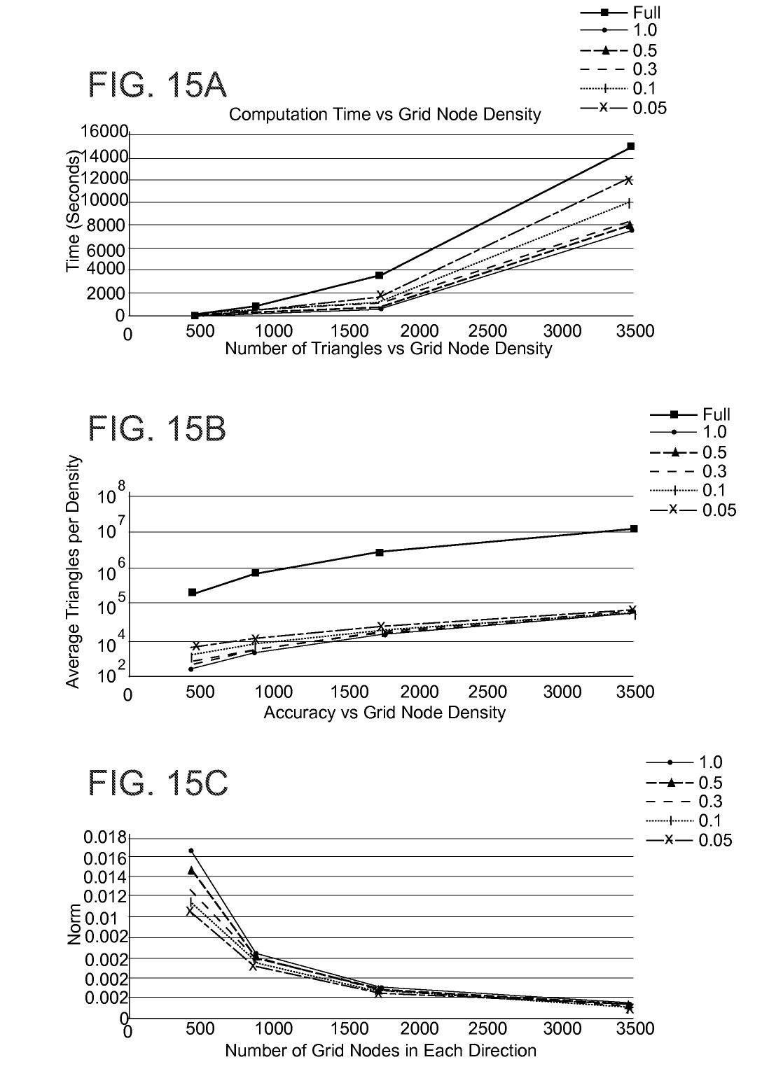

The computational results are illustrated in FIGS. 15A-C and they correspond to a varying DEM resolution and a varying global error tolerance of the adaptive triangulation based terrain correction. For these calculations, 2703 observation locations were used. The computation radius was fixed to 167 km and the initial triangle size was kept at 32 grid cells. FIG. 15A shows the time to evaluate the terrain effect for all observation locations. As the DEM resolution increases, so does the time to compute the terrain effect. The full calculation took the longest time and as the global error of the adaptive methods was decreased, their time increases. The same conclusion can be drawn about the average number of triangles used per datum in FIG. 15B. FIG. 15C presents the maximum error between the adaptive methods and the full calculation. As the global error decreases so too does the maximum error, as expected. Interestingly, the errors converge to approximately 0.001 mGal. The speed of the adaptive algorithm was calculated versus the full calculation. As the global error decreases, so does the speed. As the DEM resolution increases, the speed goes down. The reduction in the number of triangles per datum is far greater than the reduction in the computation time. The poor performance of the algorithm at denser DEM resolutions is due one factor, the limitation on the initial triangle size. All of these examples use an initial triangle size of just 32 grid cells, and as such the adaptive nature of the triangulation for the dense DEMs is not fully utilized.

To summarize, for a DEM with a 1000 m grid node spacing, a 167 km computation radius, an initial triangle size of 32 grid cells and a global error tolerance of 1.0 mGal, the adaptive method will yield a 100 times reduction in the number of triangles per datum, a reduction in computation time of 14 times and achieve a maximum error in the data of 0.0166 mGal. The time to compute the terrain effect was 15.156 seconds as opposed to 216.14 seconds for the full calculation. In this case, the user given global error tolerance is 1.0 mGal, but the final maximum error is as small as 0.0166 mGal. This suggests that a user can specify a tolerance much larger than it should be, e.g., 10 mGal. Thus, it is possible to suggest a way to estimate a more proper number. For example, it is possible to first select a small number of representative stations, run the method algorithm with different tolerance values, identify the proper one, and then apply this tolerance to all stations in the data set.

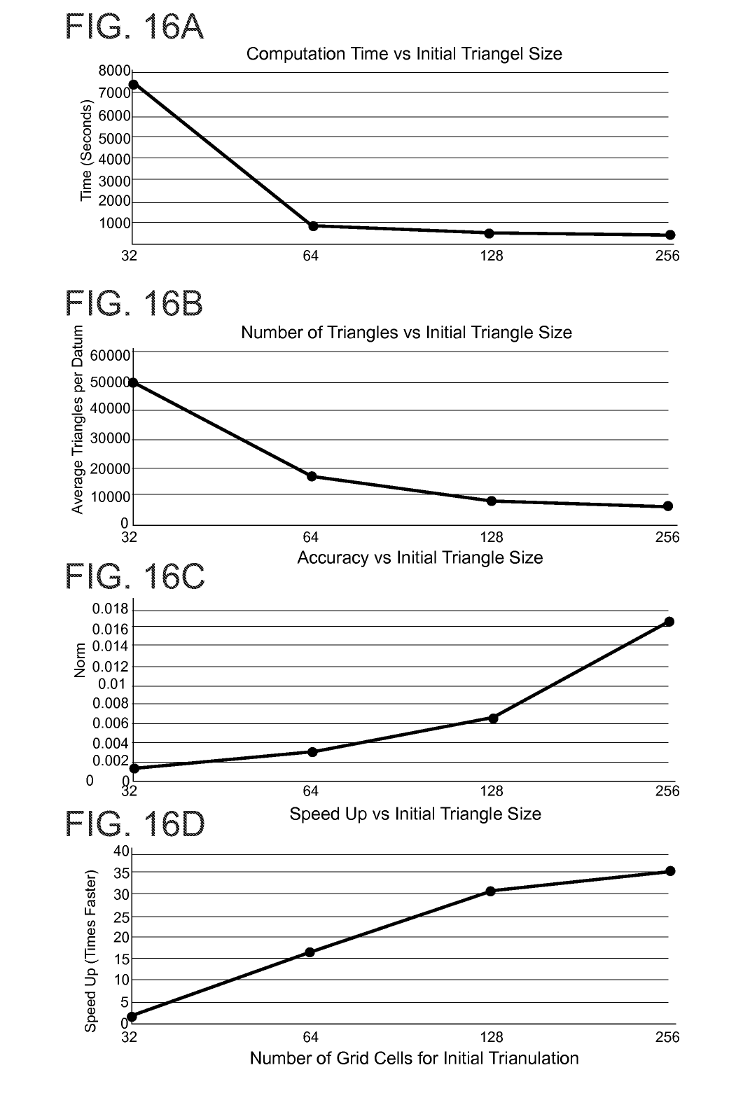

The behavior of the adaptive algorithm in this first computational analysis section is of no surprise given the restrictive size of the initial triangles. Now, the analysis proceeds to the finest resolution DEM with 3489 by 3489 grid nodes at 125 m spacing. The computational cost aspects are monitored as the initial triangle size is increased. The adaptive method is applied using initial triangle sizes of 32, 64, 128, and 256 grid cells. The global error is fixed to 1.0 mGal and the computation radius again to 167 km. FIG. 16A presents the computation time for the terrain evaluation. As the initial triangle size is increased, the computation time dramatically decreases as does the number of triangles per datum, as illustrated in FIG. 16B. The accuracy of the adaptive method, shown in FIG. 16C increases as the initial triangle size increases. However, the maximum amount of error for the four computations is just 0.0167 mGal. As before, an initial triangle size of 32 yields only 2 times speed up over full calculation. For initial sizes of 64, 128, and 256 grid cells, however, it is noted an increase in speed up, up to 35 times faster.

To summarize, for a DEM with a 125 m grid node spacing, a 167 km computation radius, an initial triangle of 256 grid cells and a global error tolerance of 1.0 mGal, the adaptive method yielded a 1760 times reduction in the number of triangles per datum, a reduction in computation time of 35 times and achieved a maximum error in the data of 0.0167 mGal comparative to a traditional calculation. The time to compute the terrain effect was 417 seconds (roughly 7 minutes) as opposed to 14742.1 seconds (roughly 4 hours) for the traditional full calculation.

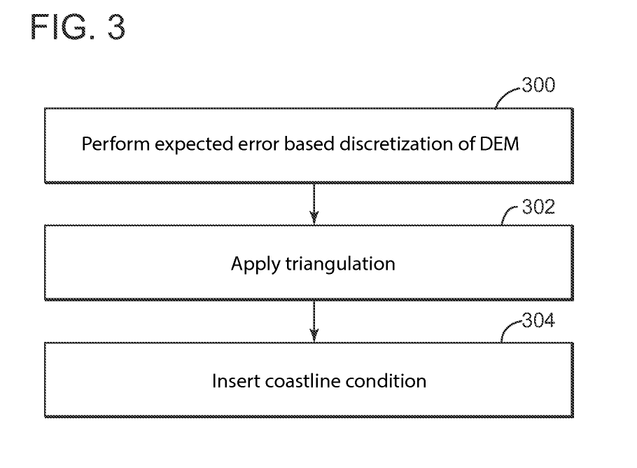

All these calculations indicate that the method discussed above with reference to FIG. 3 is faster than the traditional methods. This method uses a user error-based adaptive triangulation technique to compute the complete Bouguer effects from a DEM at an arbitrary set of observation locations. The method is applicable to land, airborne, and ship-borne surveys and provide robust computations in all three cases. For DEMs that contain the coastline, the method can handle the insertion of the coastline into the triangulation. This maintains an accurate and flexible representation of the coastline in the triangulation and prevents triangular facets from spanning the coastline contour. The examples discussed here show up to 35 times speed up using the adaptive method in comparison to a computation using the entire set of grid nodes. These calculations also show that a combination of an analytical and numerical solution of the gravity response provides an accuracy and computational efficiency. It was noted that despite error tolerances specified of 1 mGal, the method obtains a far smaller final total error in the gravity response due to the terrain driven adaptive nature.

Additionally, modifications, additions, or omissions may be made to this method without departing from the scope of the present disclosure. For example, the order of the steps may be performed in a different manner than that described and some steps may be performed at the same time. Additionally, each individual step may include additional steps without departing from the scope of the present disclosure.

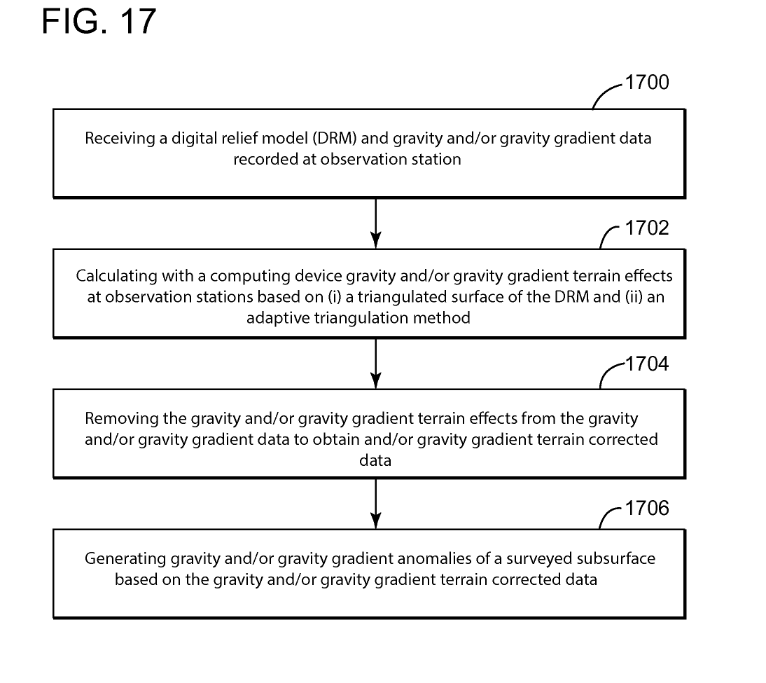

For example, the method may be modified as illustrated in FIG. 17. More specifically, a method for calculating gravity and gravity gradient terrain corrections includes a step 1700 of receiving a digital relief model (DRM) and gravity and/or gravity gradient data recorded at observation stations, a step 1702 of calculating with a computing device gravity and/or gravity gradient terrain effects at observation stations based on (i) a triangulated surface of the DRM and (ii) an adaptive triangulation method; a step 1704 of removing the gravity and/or gravity gradient terrain effects from the gravity and/or gravity gradient data to obtain gravity and/or gravity gradient terrain corrected data; and a step 1706 of generating gravity and/or gravity gradient anomalies of a surveyed subsurface based on the gravity and/or gravity gradient terrain corrected data. Gravity and/or gravity gradient anomalies are related to underground mineral resources or oil and gas and thus, such anomalies are used to generate an image of the subsurface, or a map or a grid, etc.

The gravity data is related to any one or more components of a three-component gravity field vector, and gravity gradient data is related to one or more components of a nine-component gravity gradient tensor. An observation station is a location at which a measurement or observation is made, in air, on land, at sea, in water, at water bottom, or in a borehole. In one application, the adaptive triangulation method is the adaptive Delaunay triangulation. In another application, the adaptive triangulation method is the adaptive quadtree based triangulation.

The adaptive triangulation method may use a roughness of the DRM. In one application, the adaptive triangulation method receives as input an error tolerance, and/or one or more components of a gravity field vector and/or a gravity gradient tensor to be calculated. Each received component of the gravity field vector or gravity gradient tensor may have an associated error tolerance. In one application, the adaptive triangulation method also receives as input a density distribution associated with the DRM. The density distribution has two or more values when the DRM includes land topography and marine bathymetry, and a density for a land topographic mass or a mass below the water bottom is constant or variable. The DRM includes land topography and marine bathymetry. The method may also include inserting a coastline that defines a boundary between land topography and marine bathymetry or a water body, and/or calculating the gravity and/or gravity gradient terrain effects due to a triangular prism by using a closed-form formulae or the Gaussian quadrature. The gravity data may include measurements made with a gravimeter directly or a gravity value derived from other measurement results, and gravity gradient data include measurements made with a gravity gradiometer directly or a gravity gradient value derived from other measurement results.

The DRM includes both land topographic surface elevation values and water depth values. A DTM (digital terrain model) it is used for land topography only while the DEM (digital elevation model) is almost the same as DTM and is used for land topography only. A DBM (digital bathymetric model) is used for bathymetry (water depths) only. The embodiments discussed herein equally apply to any of these models.

Although the terms used herein are known in the art, some of them are defined as follows:
Letters U, T, G or g are used in the art to denote the gravity and gradient components;
U is typically a scalar potential, Tᵢ is a component of the field vector and Tᵢⱼ is a component of the gradient tensor;
Gravimetry or the gravity survey uses a gravimeter to measure the gravity field. Conventional gravimeters measure only the vertical component of the gravity field vector;
Gravity gradiometry or the gravity gradient survey uses a gravity gradiometer to measure one or more components of the gravity gradient tensor;
The gravity and gravity gradients are a function of the mass and the distance between a mass body and a gravity station, or observation station. The gravity related data means gravity data and/or gravity gradients data;
Gravity and gravity gradient data measured anywhere on or near the Earth's surface is a superimposition of the effects due to all masses inside, outside and on the surface of the Earth (and the imperfection of the gravimeter or gravity gradiometer itself);
Gravity and gravity gradient corrections are calculated to remove these unwanted effects, e.g., effects due to land topographic relief and water (marine) bathymetric relief, which are the most significant because of the great density contrast between air and topographic rocks and between water and sediments and also because of the immediate proximity to gravity and gravity gradient observation locations. The process of computing and removing these effects are called gravity and gravity gradient terrain corrections;
Detection of small geological targets is better with gravity and/or gravity gradient data obtained with a high accuracy and thus a precise evaluation of the effects due to topography and bathymetry is desired;
Gravity effects are mainly produced by horizontal and not vertical density variations. Prims with a flat top, as used in the traditional methods, introduce artificial vertical boundaries and artificial horizontal density variations. A triangulation method can handle topographic and/or bathymetric relief defined by irregularly-distributed data points;
The conic prism and rectangular prism based methods create artificial vertical steps and thus, they form artificial horizontal density variations, producing less accurate gravity and gravity gradient results.

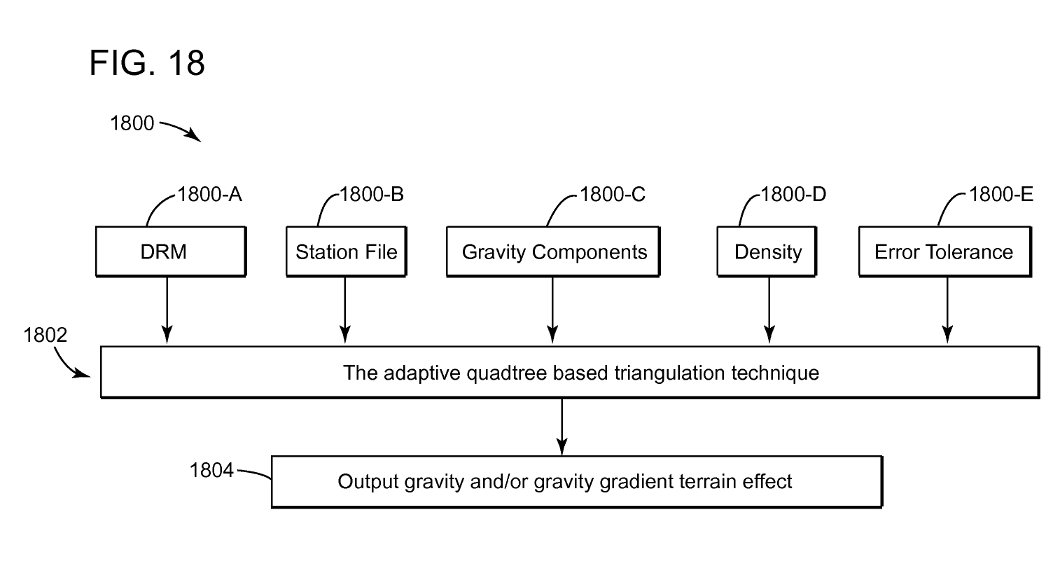

According to an embodiment illustrated in FIG. 18, a method for calculating gravity and/or gravity gradient terrain effects includes a step 1800 of receiving input data, a step 1802 of applying an adaptive quadtree based triangulation technique, and a step 1804 of outputting gravity and/or gravity gradient terrain effects. The gravity and/or gravity gradient terrain effects may be used to generate an image of the surveyed subsurface.

The input data in step 1800 may include various components. For example, a first component 1800-A may be a Digital Relief Model (DRM), which is a regular grid of topographic elevation and/or bathymetric data. A second component 1800-B may be a station file that contains the (northing, easting, elevation) coordinates of gravity stations (at points, along lines, or on a grid). A third component 1800-C includes gravity components. The gravity components are selected for computation of terrain effects and they may include: the gravity T_{D}, seven gravity gradient components T_{NN}, T_{NE}, T_{ND}, T_{EE}, T_{ED}, T_{DD}, T_{UV} (=(T_{NN}−T_{EE})/2). N is for the north, E for the east, and D for the vertical down. A forth component 1800-D includes the density. The density can be (i) a constant value in either the pure land or the pure marine case, (ii) two constant values in the case involving both land topography and marine bathymetry, or (iii) a variable density model (grid). A fifth component 1800-E may be the user-defined error tolerance. The user defined error tolerance is the allowable RMS error for each of the selected gravity components.

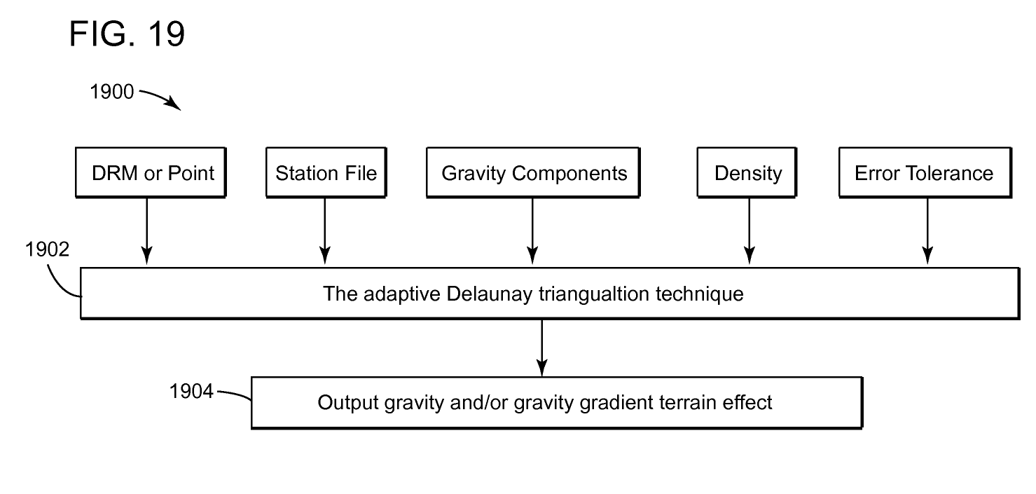

An alternative method is illustrated in FIG. 19 and this method is similar to the method illustrated in FIG. 18, except that in step 1902, instead of using the adaptive quadtree based triangulation technique, the adaptive Delaunay triangulation technique is used. Optionally, the DRM component in step 1900 may accept topography/bathymetry defined either by a DEM or a set of irregularly-distributed data points.

The input relief data in a grid or a regular distribution can be very dense and large. Downsampling may be used to maintain the relief information content while discarding data points or reducing the number of data points. The reduction of the number of data is achieved using two properties: (1) the smoothness (or roughness) of the relief, and (ii) the distance of the data point from a gravity station (the Newton's law states that the gravity is inversely proportional to the square of the distance between a mass body and a gravity station, and the gravity gradient is inversely proportional to the cube of the distance). In one application, a Delaunay triangulation is applied to the adaptive downsampled relief data. In another application, the coastline is also used as a constraint (boundary) in a final triangulation.

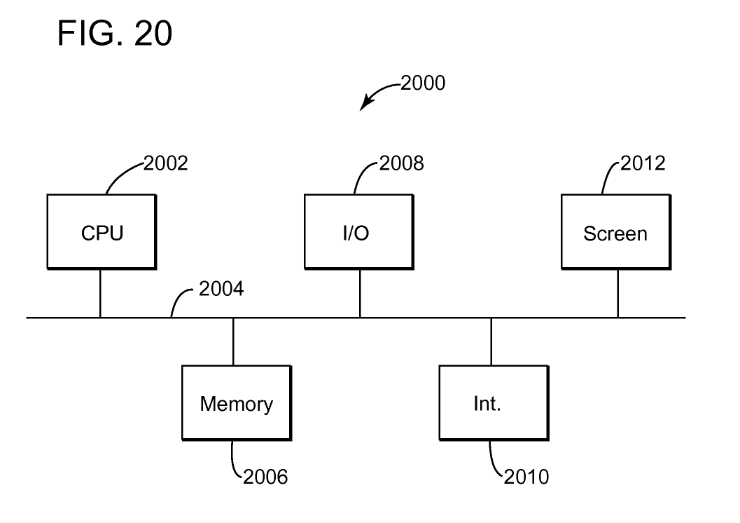

The methods and algorithms discussed above may be implemented in a computing device 2000 as illustrated in FIG. 20. The computing device 2000 may include a processor 2002, a computer, a server, etc. connected through a bus 2004 to a storage device 2006. The storage device 2006 may be any type of memory and may store necessary commands and instructions associated with collecting and processing gravity data. Also connected to the bus 2004 is an input/output interface 2008 through which the operator may interact with the calculations. A communication interface 2010 is also connected to the bus 2004 and is configured to transfer information between the processor 2002 and an outside network, Internet, operator's internal network, etc. The communication interface 2010 may be wired or wireless. Optionally, computing device 2000 may include a screen 2012 for displaying various results generated by the algorithms discussed above. For example, the positions of the vessels along various laces may be displayed on the screen 2012.

The above-disclosed embodiments provide a system and a method for calculating gravity and gravity gradient terrain effects. It should be understood that this description is not intended to limit the invention. On the contrary, the exemplary embodiments are intended to cover alternatives, modifications and equivalents, which are included in the spirit and scope of the invention as defined by the appended claims. Further, in the detailed description of the exemplary embodiments, numerous specific details are set forth in order to provide a comprehensive understanding of the claimed invention. However, one skilled in the art would understand that various embodiments may be practiced without such specific details.

Although the features and elements of the present embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in

Although the present disclosure and its advantages have been described in detail, it should be understood that various changes, substitutions and alterations can be made herein without departing from the spirit and scope of the disclosure as defined by the following claims.

1. A method for calculating gravity and gravity gradient terrain effects, the method comprising:
receiving a digital relief model (DRM) and gravity and/or gravity gradient data recorded at observation stations;
calculating with a computing device gravity and/or gravity gradient terrain effects at observation stations based on (i) a triangulated surface of the DRM and (ii) an adaptive triangulation method;
removing the gravity and/or gravity gradient terrain effects from the gravity and/or gravity gradient data to obtain gravity and/or gravity gradient terrain corrected data; and
generating gravity and/or gravity gradient anomalies of a surveyed subsurface based on the gravity and/or gravity gradient terrain corrected data.

2. The method of claim 1, wherein gravity data is related to any one or more components of a three-component gravity field vector, and gravity gradient data is related to one or more components of a nine-component gravity gradient tensor.

3. The method of claim 1, wherein an observation station is a location at which a measurement or observation is made, in air, on land, at sea, in water, at water bottom, or in a borehole.

4. The method of claim 1, wherein the adaptive triangulation method is the adaptive Delaunay triangulation.

5. The method of claim 1, wherein the adaptive triangulation method is the adaptive quadtree based triangulation.

6. The method of claim 1, wherein the adaptive triangulation method uses a roughness of the DRM.

7. The method of claim 1, wherein the adaptive triangulation method receives as input an error tolerance.

8. The method of claim 7, wherein the adaptive triangulation method also receives as input one or more components of a gravity field vector and/or a gravity gradient tensor to be calculated.

9. The method of claim 8, wherein each received component of the gravity field vector or gravity gradient tensor has an associated error tolerance.

10. The method of claim 1, wherein the adaptive triangulation method also receives as input a density distribution associated with the DRM.

11. The method of claim 10, wherein the density distribution has two or more values when the DRM includes land topography and marine bathymetry, and a density for a land topographic mass or a mass below the water bottom is constant or variable.

12. The method of claim 1, wherein the DRM includes land topography and marine bathymetry.

13. The method of claim 1, further comprising:
inserting a coastline that defines a boundary between land topography and marine bathymetry or a water body.

14. The method of claim 1, further comprising:
calculating the gravity and/or gravity gradient terrain effects due to a triangular prism by using a closed-form formulae or the Gaussian quadrature.

15. The method of claim 1, wherein the gravity data include measurements made with a gravimeter directly or a gravity value derived from other measurement results, and gravity gradient data include measurements made with a gravity gradiometer directly or a gravity gradient value derived from other measurement results.

16. A computing device for calculating gravity and gravity gradient terrain effects, the computing device comprising:
an interface for receiving a digital relief model (DRM) and gravity and/or gravity gradient data recorded at observation stations; and
a processor connected to the interface and configured to,
calculate gravity and/or gravity gradient terrain effects at observation stations based on (i) a triangulated surface of the DRM and (ii) an adaptive triangulation method,
remove the gravity and/or gravity gradient terrain effects from the gravity and/or gravity gradient data to obtain gravity and/or gravity gradient terrain corrected data, and
generate gravity and/or gravity gradient anomalies of a surveyed subsurface based on the gravity and/or gravity gradient terrain corrected data.

17. The computing device of claim 16, wherein gravity data is related to any one or more components of a three-component gravity field vector, and gravity gradient data is related to one or more components of a nine-component gravity gradient tensor.

18. The computing device of claim 16, wherein the adaptive triangulation method is the adaptive Delaunay triangulation or an adaptive quadtree based triangulation.

19. The computing device of claim 16, wherein the adaptive triangulation method receives as input an error tolerance.

20. A non-transitory computer readable medium including computer executable instructions, wherein the instructions, when executed by a processor, implement instructions for calculating gravity and gravity gradient terrain effects, the instructions comprising:
receiving a digital relief model (DRM) and gravity and/or gravity gradient data recorded at observation stations;
calculating with a computing device gravity and/or gravity gradient terrain effects at observation stations based on (i) a triangulated surface of the DRM and (ii) an adaptive triangulation method;
removing the gravity and/or gravity gradient terrain effects from the gravity and/or gravity gradient data to obtain gravity and/or gravity gradient terrain corrected data; and
generating gravity and/or gravity gradient anomalies of a surveyed subsurface based on the gravity and/or gravity gradient terrain corrected data.
